(19) United States
(12) Patent Application Publication
(10) Pub. No.: US 2008/0013901 A1
(43) Pub. Date: Jan. 17, 2008

(54) Macro-bending insensitive optical fiber

(75) Inventors: Jin-Haing Kim, Gumi-si (KR); Mun-Hyun Do, Chilgok-gun (KR); Young-Sik Yoon, Chilgok-gun (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/598,583

(22) Filed: Nov. 13, 2006

(30) Foreign Application Priority Data
Jun. 29, 2006 (KR) 2006-59533

(51) Int. Cl. G02B 6/02

(52) U.S. Cl. 385/123

(57) ABSTRACT

Disclosed is an optical fiber, which includes: a core positioned at the center of an optical fiber to have the maximum refractive index within the optical fiber; an inner clad surrounding the core to have the minimum refractive index within the optical fiber; and an outer clad surrounding the inner clad to have a refractive index lower than that of the core and higher than that of the inner clad, wherein a difference Δn_{core-inner}_{_{—}}_{clad} between the refractive index of the core and the minimum refractive index of the inner clad is within the range of 0.00615 to 0.00645, and a difference Δnₒᵤₜₑᵣ_{_{—}}_{clad-inner}_{_{—}}_{clad} between the refractive index of the outer clad and the minimum refractive index of the inner clad is 0.0006 or more.

### CLAIM OF PRIORITY

This application claims priority to an application entitled “Macro-Bending Insensitive Optical Fiber,” filed with the Korean Intellectual Property Office on Jun. 29, 2006 and assigned Serial No. 2006-59533, the contents of which are incorporated herein by reference.

### BACKGROUND OF THE INVENTION

1. Field of the Invention

The present invention relates to an optical fiber and more particularly to an optical fiber in which macro-bending loss is negligibly small, i.e., within a pre-determined tolerance of zero macro-bending loss.

2. Description of the Related Art

In general, macro-bending refers to a loss caused by bending an optical fiber at a predetermined curvature.

An optical fiber applied to an optical subscriber network, such as a Fiber-To-The-x (FTTx) network, should sufficiently meet mechanical and environmental requirements to be suitable for environments such as outdoor exposure, indoor wiring and the like, and particularly have small macro-bending loss. Further, a Coarse Wavelength Division Multiplexing (CWDM) scheme generally applied to the optical subscriber network requires an optical fiber with a small OH loss.

Recently, in order to reduce macro-bending loss, a technique has been proposed for decreasing a Mode Field Diameter (MFD). However, there is a problem with this proposal in that, since such an optical fiber with a small MFD has a large connection loss when linking with other optical fibers and a large OH loss, the compatibility of the optical fiber with a Low Water Peak Fiber (LWPF) is decreased.

Accordingly, there is a need for an optical fiber with an MFD, with which connection loss is not substantially increased and with which both macro-bending loss and OH loss are small.

### SUMMARY OF THE INVENTION

The present invention provides an optical fiber having an MFD with which connection loss is not largely increased and with which both macro-bending loss and OH loss are small.

According to a first aspect of the present invention, there is provided an optical fiber, comprising: a core positioned at the center of the optical fiber said core having a maximum refractive index within the optical fiber; an inner clad surrounding the core said inner clad having a minimum refractive index within the optical fiber; and an outer clad surrounding the inner clad said outer clad having a refractive index lower than that of the core and higher than that of the inner clad, wherein a difference Δn_{core-inner}_{_{—}}_{clad} between the refractive index of the core and the minimum refractive index of the inner clad is within the range of 0.00615 to 0.00645, and a difference Δnₒᵤₜₑᵣ_{_{—}}_{clad-inner}_{_{—}}_{clad} between the refractive index of the outer clad and the minimum refractive index of the inner clad is 0.0006 or more.

In order to accomplish these objects of the present invention, according to a second aspect of the present invention, there is provided an optical fiber, comprising: a core positioned at the center of an optical fiber said core having a maximum refractive index within the optical fiber; an inner clad surrounding the core said inner clad having a minimum refractive index within the optical fiber; and an outer clad surrounding the inner clad said outer clad having a refractive index lower than that of the core and higher than that of the inner clad, wherein the optical fiber has a macro-bending loss of 0.2 dB or less in a wavelength of 1625 nm in a case where the optical fiber is wound once around a cylinder with a diameter of 20 mm.

### BRIEF DESCRIPTION OF THE DRAWINGS

The above and other features and advantages of the present invention will be more apparent from the following detailed description taken in conjunction with the accompanying drawings, in which:

FIG. 1 is a flowchart illustrating a method of manufacturing an optical fiber preform according to a preferred embodiment of the present invention;

FIGS. 2 to 11 are views illustrating the manufacturing method illustrated in FIG. 1;

FIG. 12 is a view illustrating a process of drawing the macro-bending-insensitive optical fiber;

FIG. 13 is a view illustrating a refractive index profile of the macro-bending-insensitive optical fiber;

FIG. 14 is a view illustrating a connection loss characteristic of the macro-bending-insensitive optical fiber; and

FIG. 15 is a view illustrating a macro-bending loss characteristic of the macro-bending-insensitive optical fiber.

### DETAILED DESCRIPTION

Hereinafter, preferred embodiments of the present invention are described with reference to the accompanying drawings. In the following description, the same elements are designated by the same reference numerals although they are illustrated in different drawings. For the purposes of clarity and simplicity, a detailed description of known functions and configurations incorporated herein is omitted when it may make the subject matter of the present invention rather unclear.

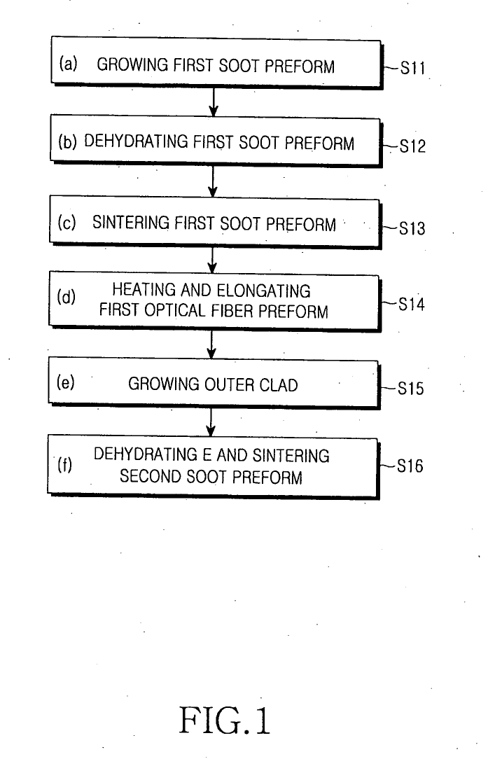

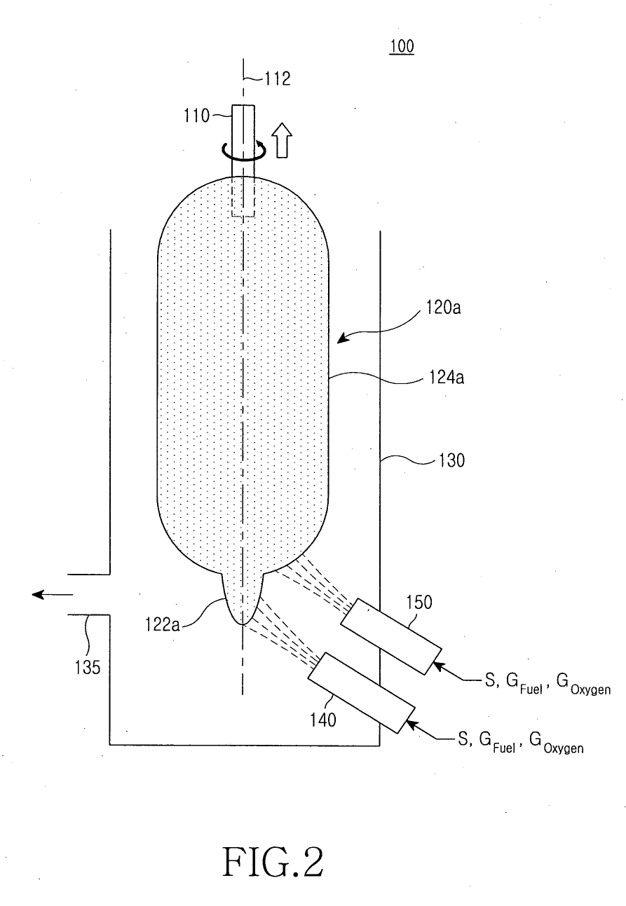

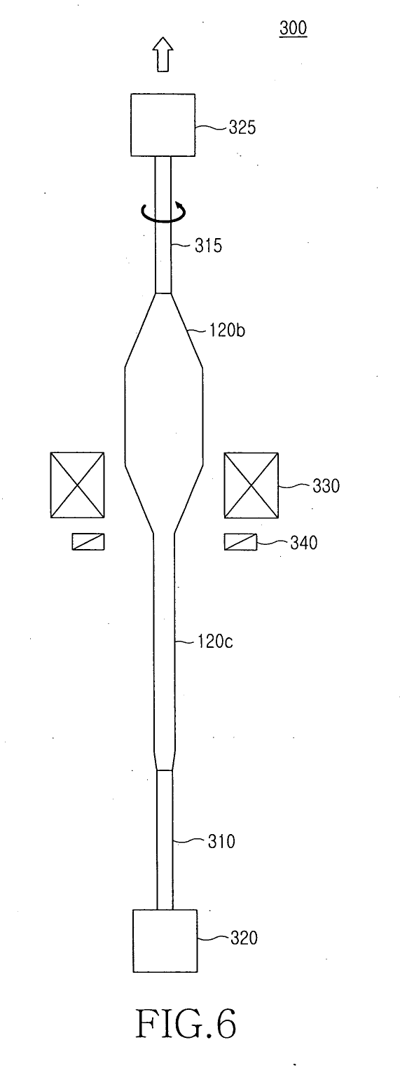

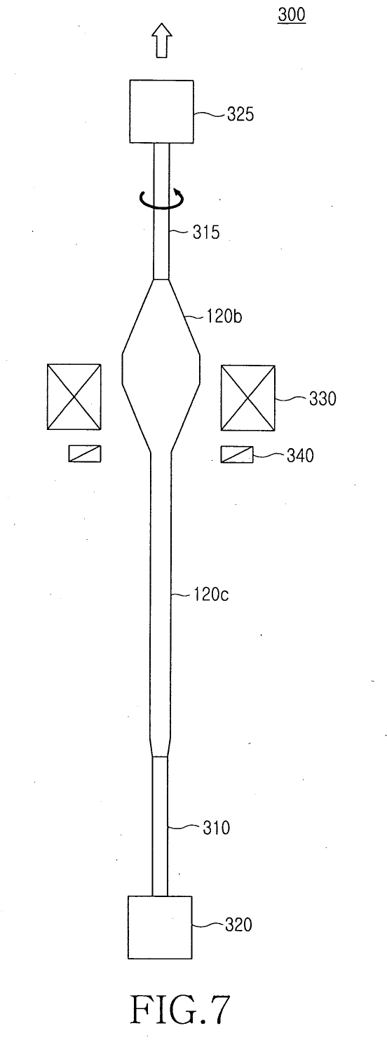

FIG. 1 is a flowchart illustrating a method for manufacturing an optical fiber preform according to a preferred embodiment of the present invention, and FIGS. 2 to 11 are views illustrating apparatus for performing the manufacturing method illustrated in FIG. 1. The manufacturing method includes processes (a) to (f) (S11 to S16).

Process (a) (S11) is a process of growing a primary soot preform along a longitudinal direction of a start member on the start member through soot deposition.

FIG. 2 is a view illustrating a manufacturing apparatus 100 for growing the primary soot preform that includes a deposition chamber 130, and a first and second burner 140 and 150.

The deposition chamber 130 has a cylindrical shape comprising an internal space. Further, the deposition chamber 130 is provided with an exhaust port 135 at one side thereof, and the first and second burner 140 and 150 are installed at an other side of the deposition chamber 130 opposite the one side.

In a preparation process before process (a) (S11), a start member 110 is installed inside the deposition chamber 130. A primary soot preform 120a is grown along a longitudinal direction of the start member 110 from an end thereof through soot deposition. The primary soot preform 120a includes a core 122a positioned at a center thereof and an inner clad 124a formed directly on an outer circumference of the core 122a. The core 122a has a relatively high refractive index, and the inner clad 124a surrounding the core 122a has a relatively low refractive index. At the beginning of the soot deposition, soot is deposited on the end of the start member 110 using the second burner 150 to form a ball. When the ball reaches a predetermined size by continuously depositing the soot, the core 122a and the inner clad 124a are simultaneously formed on the ball using the first and second burner 140 and 150. In a case where the primary soot preform 120a is grown directly on an end of the start member 110 without the formation of the ball, the start member 110 and the primary soot preform 120a may be separated from each other, or cracks may be produced in the primary soot preform 120a due to the weight of the primary soot preform 120a. The start member 110 simultaneously rotates about the center and moves away from the first and second burner 140 and 150 during the soot deposition. The start member 110 is rotated about a central axis 112 thereof as the center such that the primary soot preform 120a has rotational symmetry. Further, the start member 110 is moved away from the first and second burner along the central axis 112 thereof such that the primary soot preform 120a is continuously grown toward the first and second burner 140 and 150. Along the central axis 112 of the start member 112, in a preferred embodiment, the growth direction of the primary soot preform 120a is downward and the reverse direction thereof is upward. The upward movement of the start member 110 is servo-controlled using a sensor. That is, the sensor measures a growth size selected from the group consisting of a diameter or a length, and the start member 110 is moved upwardly if the growth size of the primary soot preform 120a approaches a predetermined value. Thus, the start member 110 is automatically moved upward depending on the growth size of the primary soot preform 120a.

The first burner 140 has a central axis inclined at an acute angle with respect to the central axis 112 of the start member 110, and jets flames toward an end of the primary soot preform 120a such that the core 122a is downwardly grown from the end of the primary soot preform 120a. A glass raw material S (SiCl₄, GeCl₄, POCl₃, CF₄, BCl₃ or the like), a fuel gas G_{Fuel} containing hydrogen, an oxidation gas G_{oxygen} containing oxygen, and the like are provided to the first burner 140. Soot is produced in accordance with a chemical reaction in which the glass raw material is hydrolyzed within the flames jetted from the first burner 140, and the like. Further, the produced soot is deposited on the primary soot preform 120a.

Hydrolysis reaction formulas of SiO₂ and GeO₂, which are main oxides constituting the soot, are shown as the following Chemical Formulas 1 and 2. At this time, the reaction temperature is in the range of 700 to 900° C.

SiCl₄+2H₂O→SiO₂+4HCl (1)

GeCl₄+2H₂O→GeO₂+4HCl (2)

The second burner 150 is upwardly spaced apart from the first burner 140, and a central axis of the second burner 150 is inclined at an acute angle with respect to the central axis 112 of the start member 110. The second burner 150 jets flames toward an outer circumferential surface of the core 122a such that the inner clad 124a is grown on the outer circumferential surface of the core 122a. A glass raw material S (SiCl₄, GeCl₄, POCl₃, CF₄, BCl₃ or the like), a fuel gas G_{Fuel} containing hydrogen, an oxidation gas G_{oxygen} containing oxygen, and the like, are provided to the second burner 150. Soot is produced in accordance with a chemical reaction in which the glass raw material is hydrolyzed within the flames jetted from the second burner 150, and the like. Further, the produced soot is deposited on the primary soot preform 120a.

The supply quantities or kinds of the glass raw materials S respectively provided to the first and second burners 140 and 150 are controlled to be different from each other, so that the core 122a has a refractive index higher than the inner clad 124a. For example, GeO₂ and P₂O₅ within glass increase a refractive index, and B₂O₃ and F decrease it. Soot that has not been deposited on the primary soot preform 120a from among the soot produced by the first and second burners 140 and 150 is exhausted to the outside through the exhaust port 135.

Process (b) (S12) is a process of dehydrating the primary soot preform 120a. That is, the primary soot preform 120a is heated in a chlorine (Cl₂) atmosphere so that OH group and impurities existing inside the primary soot preform 120a are removed.

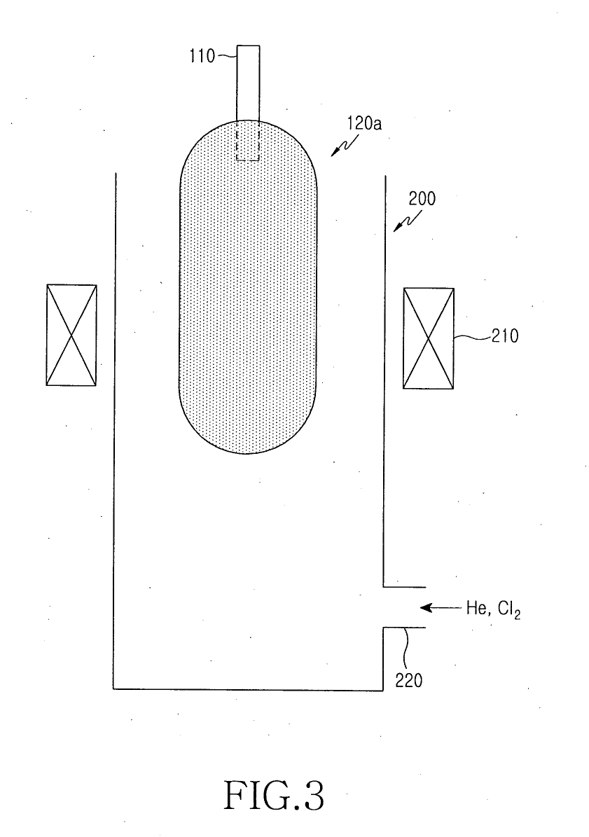

FIG. 3 is a view illustrating an apparatus for dehydrating the first soot preform 120a. A furnace 200 illustrated in FIG. 3 is provided with a heater 210 and an inflow port 220 below the heater 210.

In a preparation process before process (b) (S12), the primary soot preform 120a is installed inside the furnace 200. Cl₂ and He gas is provided to the inside of the furnace 200 through the inflow port 220, and the primary soot preform 120a is heated using the heater 210. Preferably, the input of the He gas is 20 to 50 splm, and the input of the Cl₂ gas is 2 to 5 vol % of that of the He gas. For example, the primary soot preform 120a may be heated at 1130° C. for 120 minutes under an atmosphere of the Cl₂ gas of 1.0 splm and the He gas of 25 splm.

Process (c) (S13) is a process of obtaining a primary vitrified soot preform by sintering the primary dehydrated soot preform 120a.

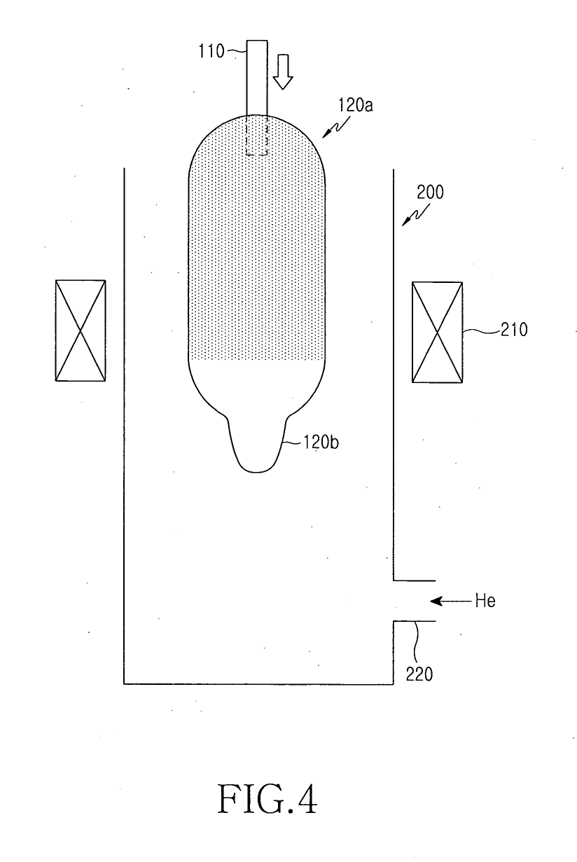

FIG. 4 is a view illustrating an apparatus for sintering the primary dehydrated opaque soot preform 120a using the furnace 200 illustrated in FIG. 3. In a state where the primary dehydrated soot preform 120a is installed inside the furnace 200, He gas is provided to an inside of the furnace 200 through the inflow port 220, and the primary dehydrated soot preform 120a is heated using the heater 210. The primary dehydrated soot preform 120a is moved downward such that it passes from a bottom to a top of a high-temperature region formed inside the furnace 200 by the heater 210. A primary vitrified optical fiber preform 120b is obtained by performing the sintering process. That is, the primary opaque soot preform 120a is changed into a primary transparent optical fiber preform 120b through the sintering process. Since He gas has a high thermal conductivity, it conducts heat up to the inside of the primary soot preform 120a. Preferably, the input of the He gas is 20 to 50 splm. For example, the primary soot preform 120a may be heated at 1500° C. for 200 minutes under an atmosphere of the He gas of 25.0 splm.

Process (d) (S14) is a process of stretching the primary vitrified optical fiber preform 120b by heating it using a heat source that does not use hydrogen. That is, in order to reduce the diameter of the primary vitrified optical fiber preform 120b and to extend the length thereof, an end of the primary vitrified optical fiber preform 120b is stretched in a state where the primary vitrified optical fiber preform 120b is softened. The primary vitrified optical fiber preform 120b is stretched to a predetermined diameter wherein a diameter ratio of a core and clad of a final product is determined by that of the optical fiber. The heat source that does not use hydrogen includes an electric furnace, a plasma heater and the like.

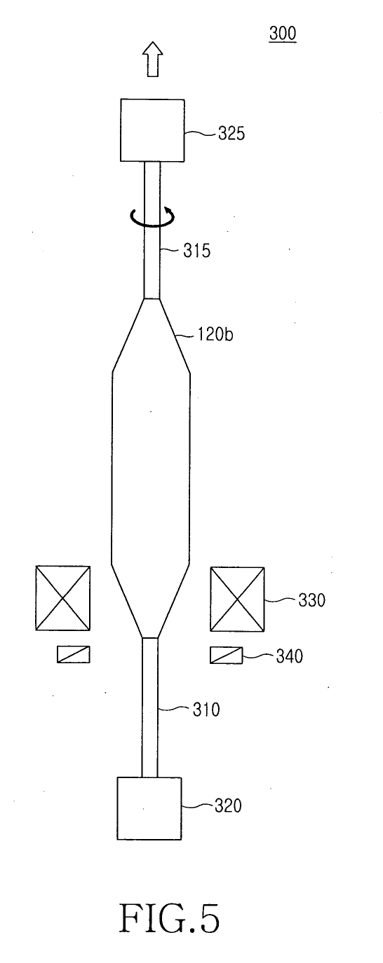

FIGS. 5 to 7 are views illustrating a sequence of states of an apparatus 300 for performing a process of heating and drawing (stretching) the primary vitrified optical fiber preform 120b to form a stretched primary vitrified optical fiber perform 120c. FIGS. 5 to 7 are views sequentially illustrating the initial, middle and last stages of process (d) (S14). A drawing apparatus 300 illustrated in FIGS. 5 to 7 includes first and second chuck 320 and 325, a furnace 330 and an outer diameter measuring device 340.

Referring to FIG. 5, in a preparation process before process (d) (S14), a first dummy rod 310 is attached to a first end of the primary vitrified optical fiber preform 120b, and a second dummy rod 315 is attached to a second end positioned opposite to the first end. The first and second dummy rods 310 and 315 are extended along a central axis (or a longitudinal direction) of the primary vitrified optical fiber preform 120b. The first dummy rod 310 is mounted on the first chuck 320, and the second dummy rod 315 is mounted on the second chuck 325. At this time, in order to prevent the primary vitrified optical fiber preform 120b from being bent during the stretching process, the primary vitrified optical fiber preform 120b is positioned perpendicular to the ground such that a first and second end thereof are respectively positioned below and above. To this end, the first and second chuck 320 and 325 are positioned below and above, respectively. The furnace 330 and the outer diameter measuring device 340 are positioned around the primary vitrified optical fiber preform 120b, and the outer diameter measuring device 340 is positioned below the furnace 330 so as to measure the diameter of the stretched primary vitrified optical fiber preform 120c.

Further, in a preparation process before process (d) (S14), the diameter of the primary vitrified optical fiber preform 120b is measured with respect to the entire length thereof using the outer diameter measuring device 340 to produce a measurement result, and the upwardly moving speed of the second chuck 325 and the furnace 330 are adjusted in accordance with the measurement result.

Referring to FIGS. 5 to 7, in a sequence of states is illustrated wherein the heating temperature of the furnace 330 is increased and the primary vitrified optical fiber preform 120b is rotated at a pre-determined speed with its central axis as a center of rotation, the furnace 330 and the outer diameter measuring device 340 are upwardly moved while constantly maintaining an interval between each other, and the second chuck 325 is upwardly moved. In the sequence of states illustrated in FIGS. 5 to 7, the furnace 330 moves from a first end to a second end of the primary vitrified optical fiber preform 120b. At this time, the moving speed of the furnace 330 is faster than that of the second chuck 325. Further, the outer diameter measuring device 340 monitors the diameter of the stretched primary vitrified optical fiber preform 120c. The rotation of the primary vitrified optical fiber preform 120b is for the purpose of preventing the development of egg-shaped anomalies and bending of the primary vitrified optical fiber preform 120b. Alternatively, the primary vitrified optical fiber preform 120b may not be rotated during process (d) (S14). Preferably, the heating temperature of the furnace 330 is 1800 to 2100° C. Further, an electric resistance furnace or an electric induction furnace may be used as the furnace 330. For example, the heating temperature of the furnace 330 may be maintained at 2000° C., the moving speed of the second chuck 325 may be 45 to 50 mm/min, the feed speed corresponding to a difference between the moving speeds of the second chuck 325 and the furnace 330 may be 7.5 mm/min, and the rotary speed of the primary vitrified optical fiber preform 120b may be 1 rpm. Further, it is preferred that the tension applied to the second chuck 325 be maintained as 100 to 200N.

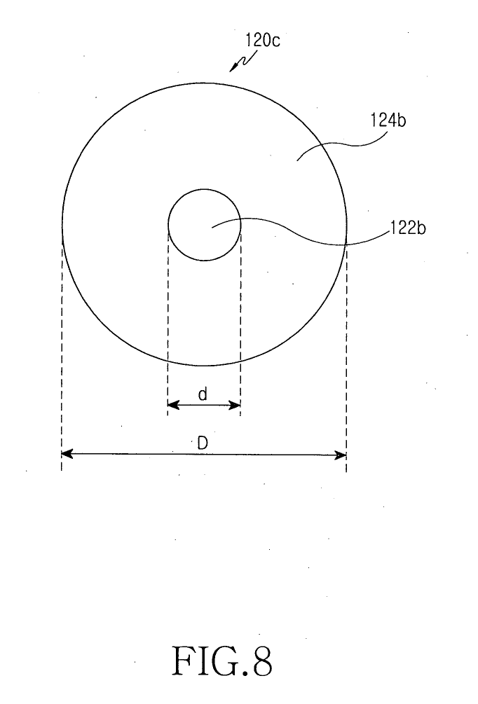

FIG. 8 is a view illustrating a section of the stretched primary vitrified optical fiber preform or first drawn optical fiber preform 120c comprising a core 122b and an inner clad 124b having a diameter thereof as d and D, respectively. Since process (d) (S14) is performed by a heat source that does not use hydrogen, the hydrogen permeation into the core 122b of the first drawn optical fiber preform 120c is minimized. Therefore, the diameter ratio D/d of the core 122b and the inner clad 124b is 5.0 or less.

Thereafter, the stretched primary vitrified optical fiber preform 120c is cut to be divided into two cut primary optical fiber preforms 120c, and one cut primary optical fiber preform 120c of the two, to which the first dummy rod 310 is attached, is used in the following processes.

Process (e) (S15) is a process of obtaining a secondary soot preform by growing an outer clad on the cut primary optical fiber preform 120c by soot deposition along a central axis direction thereof. The outer clad has a refractive index higher than the inner clad 124b of the cut primary optical fiber preform 120c and lower than the core 122b thereof. The outer clad is formed directly on the outer circumference of the inner clad 124b of the primary cut optical fiber preform 120c.

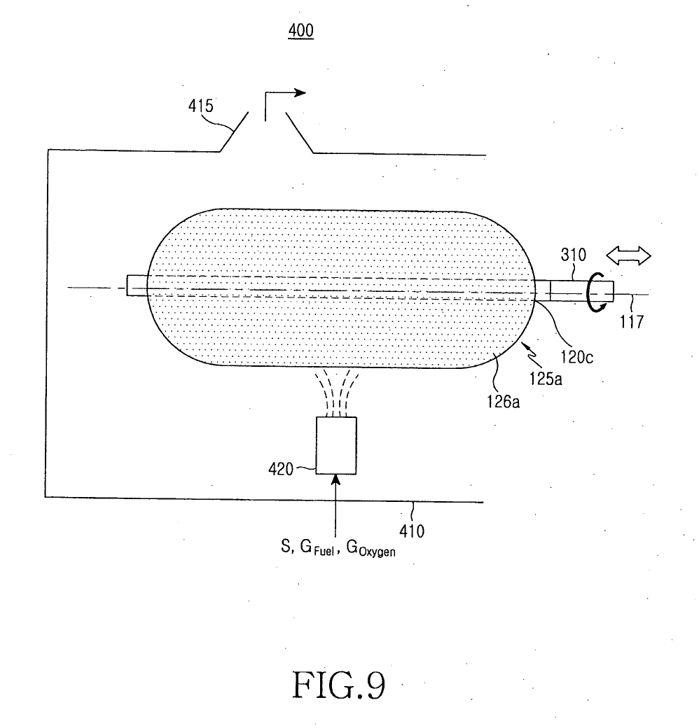

FIG. 9 is a view illustrating an apparatus 400 for growing the outer clad that includes a deposition chamber 410 and a burner 420. In a preparation process before process (e) (S15), the cut primary optical fiber preform 120c is installed inside the deposition chamber 410.

The deposition chamber 410 has a cylindrical shape with an inner space, and is provided with an exhaust port 415 at a top of the deposition chamber 410. The burner 420 is positioned opposite to the exhaust port 415 with the cut primary optical fiber preform 120c therebetween. An outer clad 126a is grown on an outer circumference of the cut primary optical fiber preform 120c through a second soot deposition using the burner 420. During the second soot deposition, the cut primary optical fiber preform 120c rotates and simultaneously moves along the central axis thereof. The cut primary optical fiber preform 120c is rotated about the central axis 117 as a center such that a secondary opaque soot preform 125a resulting from the second soot deposition has rotational symmetry. Further, the secondary soot preform 125a is obtained by repeatedly reciprocating the cut primary optical fiber preform 120c along the central axis 117 thereof. In a preferred embodiment, the burner 420 is fixed.

A raw material S containing SiCl₄, which is a glass forming substance, a fuel gas G_{Fuel} containing hydrogen or CH₄, and an oxidation gas G_{Oxygen} containing oxygen, and the like are provided to the burner 420. Soot is produced in accordance with a chemical reaction in which the raw material S is hydrolyzed within flames jetted from the burner 420, and a produced soot is deposited on an outer circumferential surface of the cut primary optical fiber preform 120c. Soot produced by the burner 420 that has not been deposited on the outer circumferential surface of the cut primary optical fiber preform 120c is exhausted to the outside through the exhaust port 415 of the deposition chamber 410.

In an alternative preferred embodiment, the burner 420 is repeatedly reciprocated along a path parallel to the central axis 117 of the cut primary cut optical fiber preform 120c.

Process (f) (S16) is a process of obtaining a secondary vitrified optical fiber preform 125b by dehydrating and sintering the secondary soot preform 125a. That is, the secondary soot preform 125a is heated in a Cl₂ gas atmosphere to perform a dehydrating process for eliminating OH group and impurities, which exist inside the secondary soot preform 125a, and the secondary soot preform 125a is simultaneously sintered under He gas atmosphere to perform a process of vitrifying the secondary soot preform 125a.

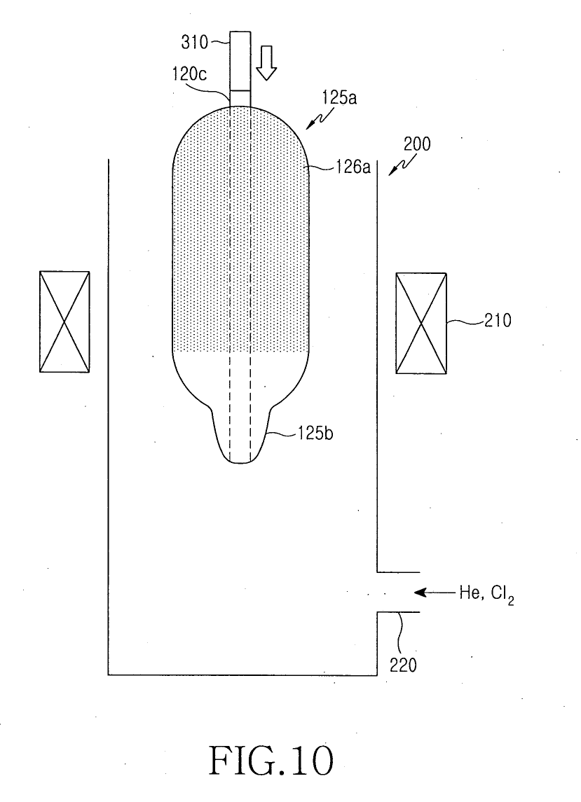

FIG. 10 is a view illustrating an apparatus for dehydrating and sintering the second soot preform 125a using the furnace 200 illustrated in FIG. 4. In a state where the secondary soot preform 125a is installed inside the furnace 200, He and Cl₂ gas is provided inside the furnace 200 through the inflow port 220, and the secondary soot preform 125a is heated using the heater 210. The secondary soot preform 125a is downwardly moved at a predetermined speed such that it passes from a top to a bottom of a high-temperature region formed inside the furnace 200 by the heater 210. OH group and impurities, which exist inside the secondary soot preform 125a, are thereby eliminated, and a secondary vitrified optical fiber preform 125b is simultaneously obtained by performing such a dehydrating and sintering process. That is, the secondary opaque soot preform 125a is changed into a secondary transparent optical fiber preform 125b through the dehydrating and sintering process.

Preferably, the input of the He gas is 10 to 20 splm, and the input of the Cl₂ gas is 1 to 4 vol % of that of the He gas. For example, the secondary soot preform 125a may be heated at 1500° C. for 300 minutes under an atmosphere of the Cl₂ gas of 0.375 splm and the He gas of 15 splm.

Conventionally, a secondary soot preform is not dehydrated but sintered. However, the secondary soot preform 125a is dehydrated and sintered in the present invention to produce a secondary transparent soot perform 125b so that there is reduced loss due to the OH group of a macro-bending-insensitive optical fiber manufactured hereafter.

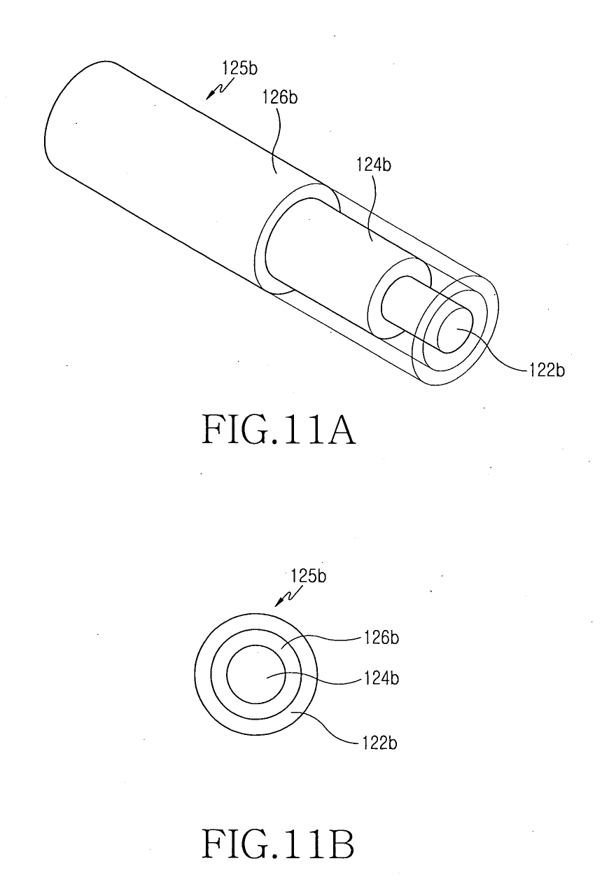

FIG. 11 is a view illustrating the secondary transparent optical fiber preform 125b. FIG. 11A illustrates a perspective view of the secondary transparent optical fiber preform 125b, and FIG. 11B illustrates a sectional view of the secondary transparent optical fiber preform 125b. As illustrated in these figures, the secondary transparent optical fiber preform 125b is composed of a core 122b positioned at the center thereof, an inner clad 124b surrounding the core 122b, and an outer clad 126b surrounding the inner clad 124b.

Thereafter, the secondary optical fiber preform 125b manufactured through the aforementioned method is drawn as a macro-bending-insensitive optical fiber through a process that will be described below. The macro-bending-insensitive optical fiber has the same configuration and diameter ratio as the secondary transparent optical fiber preform 125b. The core of the macro-bending-insensitive optical fiber becomes a transmission medium of an optical signal, the inner clad functions to trap the optical signal within the core, and the outer clad functions to increase the diameter of the macro-bending optical fiber. Further, the diameter ratio of the core, inner clad and outer clad of the macro-bending optical fiber is identical with that of the core 122b, inner clad 124b and outer clad 126b of the secondary transparent optical fiber preform 125b.

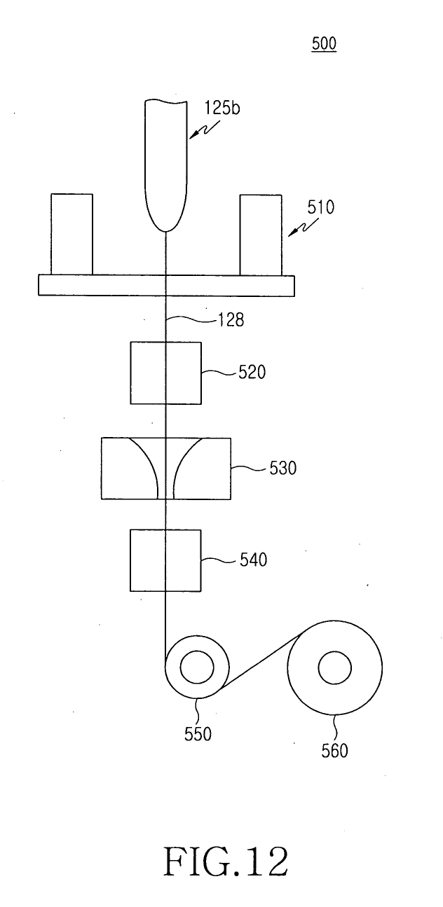

FIG. 12 is a view illustrating an apparatus 500 for drawing a macro-bending-insensitive optical fiber. A drawing apparatus 500 illustrated in FIG. 12 includes a furnace 510, a cooling device 520, a coater 530, an ultraviolet curing device 540, a capstan 550 and a spool 560.

The furnace 510 heats an end of the secondary transparent optical fiber preform 125b, which has installed inside the furnace 510, at 2000 to 2500° C. to melted the end. Although a macro-bending-insensitive optical fiber 128 drawn from the secondary transparent optical fiber preform 125b has the same configuration as the secondary optical fiber preform 125b, the diameter of the macro-bending-insensitive optical fiber 128 is much smaller than that of the secondary transparent optical fiber preform 125b. Further, in order to prevent the inside of the furnace 510 from being oxidized due to heat, an inert gas is flowed inside the furnace 510.

The cooling device 520 cools the heated macro-bending-insensitive optical fiber 128 drawn from the furnace 510.

The coater 530 applies an ultraviolet curable resin to the macro-bending-insensitive optical fiber 128 passing through the cooling device 520, and the ultraviolet curing device 540 cures the ultraviolet curable resin by radiating ultraviolet rays thereon.

The capstan 550 pulls the macro-bending-insensitive optical fiber 128 with a pre-determined force such that the macro-bending-insensitive optical fiber 128 is continuously drawn from the secondary transparent optical fiber preform 125b while maintaining a pre-determined diameter thereof.

The macro-bending-insensitive optical fiber 128 passing through the capstan 550 is wound around the spool 560.

A loss of an optical fiber in a wavelength of 1383 nm is greatly influenced by the ratio D/d of a diameter d of a core and a diameter D of an inner clad in the macro-bending-insensitive optical fiber. In the macro-bending insensitive optical fiber 128, the maximum loss value in a wavelength of 1310 to 1625 nm is 0.46 dB/km or less, and an OH loss is maintained as 0.320 dB/km or less through the double dehydration (processes (b) and (f) (S12 and S16)) in the process of manufacturing the macro-bending-insensitive optical fiber 128 and D/d of 3.9 or more. Further, a loss value in the wavelength of 1383 mm does not increase even after the macro-bending-insensitive optical fiber 128 has passed through H₂ aging, and the loss value in the wavelength of 1383 nm is less than that in a wavelength of 1310 nm even 14 days after the H₂ aging.

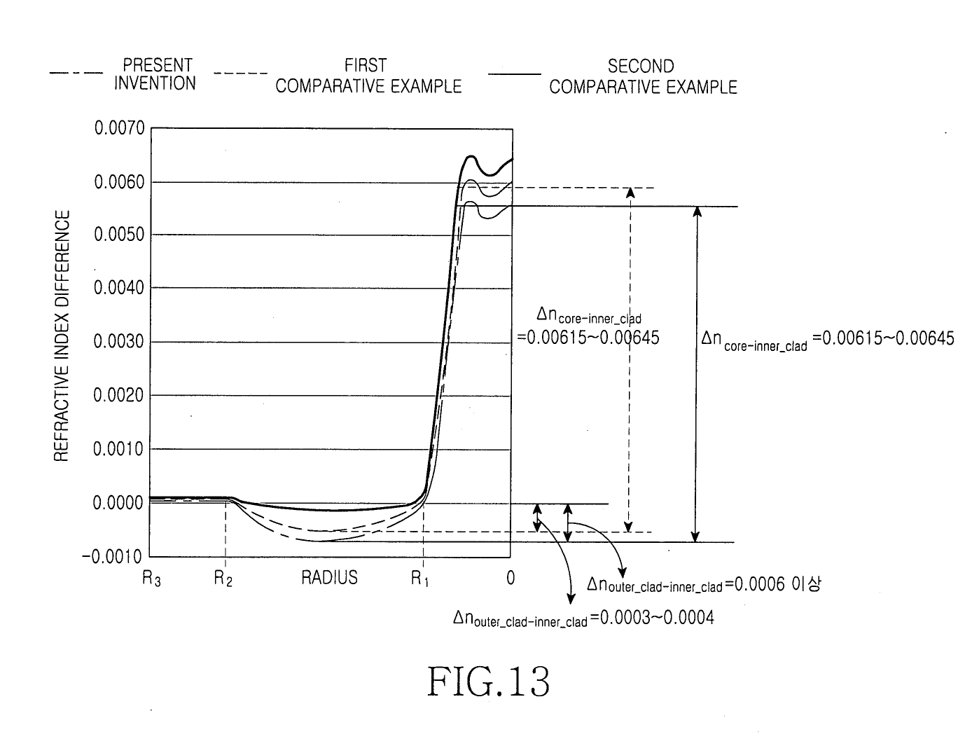

FIG. 13 is a view illustrating a refractive index profile of the macro-bending-insensitive optical fiber 128. The radii of the core and inner clad and outer clad, which constitute the macro-bending insensitive optical fiber 128, are R₁, R₂ and R₃, respectively. For example, the refractive index profile of the macro-bending-insensitive optical fiber 128 are obtained by adjusting an amount of GeCl₄ provided to the first burner 140 and that of CF₄ provided to the second burner 150 in process (a) (S11). In a case where a difference Δn_{core-inner}_{_{—}}_{clad} between the refractive index (defined by the mean value of refractive indexes if there is a shake) of the core and the minimum refractive index of the inner clad is within the range of 0.00615 to 0.00645, and a difference Δnₒᵤₜₑᵣ_{_{—}}_{clad-inner}_{_{—}}_{clad} between the refractive index of the outer clad and the minimum refractive index of the inner clad is 0.0006 or more, the macro-bending-insensitive optical fiber 128 has a macro-bending loss of 0.2 dB or less in a wavelength of 1625 nm in a case where it is wound once around a cylinder with a diameter of 20 mm.

FIG. 13 illustrates refractive index profiles of optical fibers according to first and second comparative examples, and each of the optical fibers has the same configuration of the macro-bending-insensitive optical fiber 128. For example, since the difference Δn_{core-inner}_{_{—}}_{clad} between the refractive index (defined by the mean value of refractive indexes if there is a shake) of the core and the minimum refractive index of the inner clad is within the range of 0.00615 to 0.00645, and the difference Δnₒᵤₜₑᵣ_{_{—}}_{clad-inner}_{_{—}}_{clad} between the refractive index of the outer clad and the minimum refractive index of the inner clad is within the range of 0.0003 to 0.0004 in the optical fiber according to the first comparative example, the optical fiber has a macro-bending loss more than 0.2 dB in the wavelength of 1625 nm in a case where it is wound once around a cylinder with a diameter of 20 mm. Since the optical fiber according to the second comparative example hardly has a difference between the refractive index of the outer clad and the minimum refractive index of the inner clad, the optical fiber according the second comparative example has a macro-bending loss larger than the optical fiber according the first comparative example.

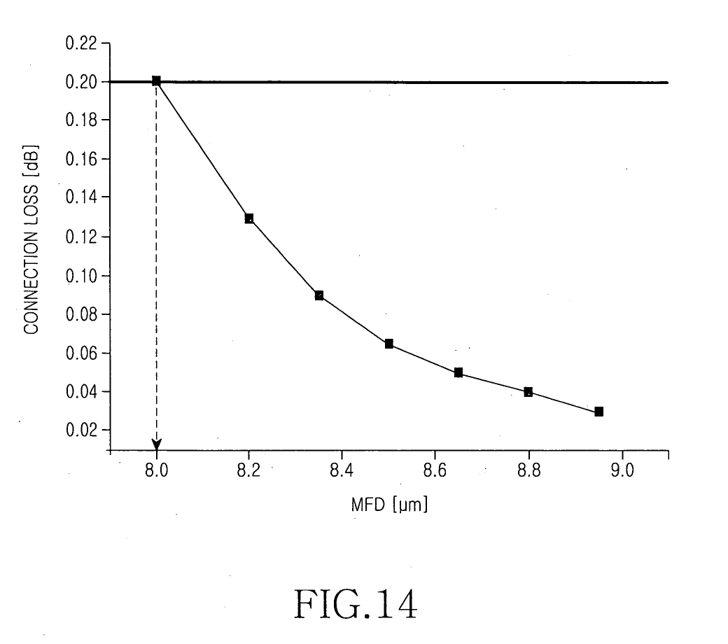

FIG. 14 is a view illustrating a connection loss characteristic of the macro-bending-insensitive optical fiber 128. In FIG. 14, the horizontal axis denotes an MFD in a wavelength of 1310 nm in the macro-bending insensitive optical fiber 128, and the vertical axis denotes the bi-directional mean connection loss value of a single mode optical fiber with an MFD of about 9.2 μm with respect to the macro-bending-insensitive optical fiber 128 in the wavelength of 1310 nm. At this time, the connection loss is measured using an Optical Time Domain Reflectometer (OTDR). As illustrated in FIG. 14, since an inverse proportion relation is imposed between the MFD and the connection loss, the macro-bending-insensitive optical fiber 128 should have an MFD of 8.0 μm or more so as to have a connection loss of 0.2 dB or less.

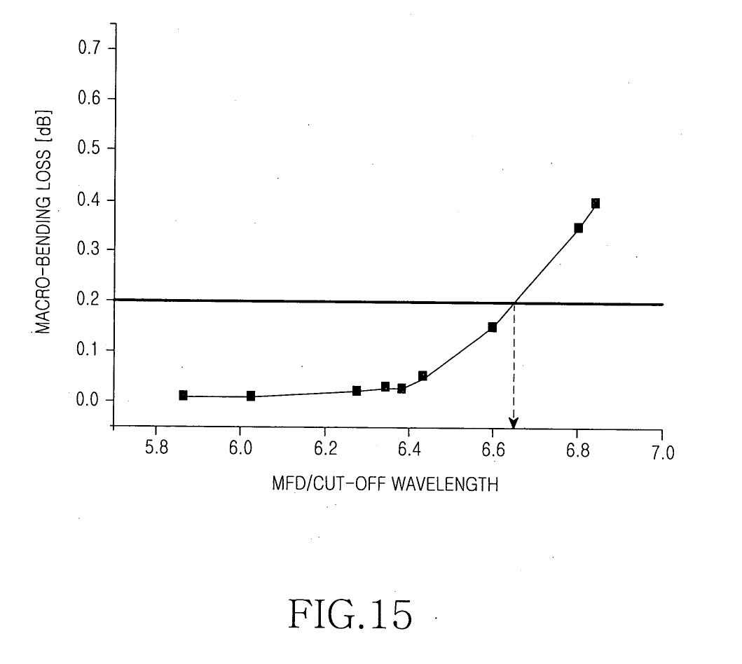

FIG. 15 is a view illustrating a macro-bending loss characteristic of the macro-bending-insensitive optical fiber 128. In FIG. 15, the horizontal axis denotes a ratio of the MFD of the macro-bending-insensitive optical fiber 128 in the wavelength of 1310 nm with respect to a cut-off wavelength, and the vertical axis denotes a macro-bending loss value. As illustrated in FIG. 15, since an exponent proportion relation is imposed between the ratio of the MFD in the wavelength of 1310 nm with respect to the cut-off wavelength and the macro-bending loss, the ratio of the MFD of the macro-bending-insensitive optical fiber 128 in the wavelength of 1310 nm with respect to a cut-off wavelength should be 6.63 or less so as to have a macro-bending loss of 0.2 dB.

As described above, there is an advantage in that, since an optical fiber according to the present invention has little OH loss and a low connection loss, it has a good compatibility with an existing LWPF. Further, since the optical fiber meets a transmission characteristic required in a CWDM optical subscriber network and has a small macro-bending loss, it is suitable for even building an optical subscriber network in an environment where bending is excessive.

While the invention has been illustrated and described with reference to certain preferred embodiments thereof, it will be understood by those skilled in the art that various changes in form and details may be made therein without departing from the spirit and scope of the invention as defined by the appended claims.

What is claimed is:

1. An optical fiber, comprising:
a core positioned at a center of an optical fiber to have a maximum refractive index within the optical fiber;
an inner clad surrounding the core, said inner clad having a minimum refractive index within the optical fiber; and
an outer clad surrounding the inner clad, said outer clad having a refractive index lower than that of the core and higher than that of the inner clad,
wherein, a difference Δn_{core-inner}_{_{—}}_{clad} between the refractive index of the core and the minimum refractive index of the inner clad is within the range of 0.00615 to 0.00645, and a difference Δnₒᵤₜₑᵣ_{_{—}}_{clad-inner}_{_{—}}_{clad} between the refractive index of the outer clad and the minimum refractive index of the inner clad is 0.0006 or more.

2. The optical fiber as claimed in claim 1, wherein the optical fiber has a Mode Field Diameter (MFD) of 8.0 μm or more in a wavelength of 1310 nm.

3. The optical fiber as claimed in claim 1, wherein the ratio (MFD/cut-off wavelength) of the MFD of the optical fiber in a wavelength of 1310 mm with respect to a cut-off wavelength is 6.6 or less.

4. The optical fiber as claimed in claim 1, wherein the optical fiber has a loss of 0.320 dB/km or less in a wavelength of 1383 nm.

5. The optical fiber as claimed in claim 1, wherein the core comprises SiO₂ and GeO₂, the inner clad comprises SiO₂ and F, and the outer clad comprises SiO₂.

6. The optical fiber as claimed in claim 1, wherein the ratio of the diameter d of the core and the diameter D of the inner clad is 3.9 or more.

7. The optical fiber as claimed in claim 1, wherein the optical fiber has a macro-bending loss of 0.2 dB or less in a wavelength of 1625 nm in a case where the optical fiber is wound once around a cylinder having a diameter of 20 mm.

8. An optical fiber, comprising:
a core positioned at a center of an optical fiber, said core having a maximum refractive index within the optical fiber;
an inner clad surrounding the core, said inner clad having a minimum refractive index within the optical fiber; and
an outer clad surrounding the inner clad, said outer clad having a refractive index lower than that of the core and higher than that of the inner clad,
wherein, the optical fiber has a macro-bending loss of 0.2 dB or less in a wavelength of 1625 nm in a case where the optical fiber is wound once around a cylinder having a diameter of 20 mm.

9. The optical fiber as claimed in claim 8, wherein the optical fiber has a Mode Field Diameter (MFD) of 8.0 μm or more in a wavelength of 1310 nm.

10. The optical fiber as claimed in claim 8, wherein the ratio (MFD/cut-off wavelength) of the MFD of the optical fiber in a wavelength of 1310 nm with respect to a cut-off wavelength is 6.6 or less.

11. The optical fiber as claimed in claim 8, wherein the optical fiber has a loss of 0.320 dB/km or less in a wavelength of 1383 nm.

12. The optical fiber as claimed in claim 8, wherein the core comprises SiO₂ and GeO₂, the inner clad comprises SiO₂ and F, and the outer clad comprises SiO₂.

13. The optical fiber as claimed in claim 8, wherein the ratio of the diameter d of the core and the diameter D of the inner clad is 3.9 or more.

14. A method for manufacturing an optical fiber, comprising the steps of:
growing a primary soot preform along a longitudinal direction of a start member on the start member through soot deposition;
dehydrating the grown primary soot preform;
sintering the dehydrated primary soot preform to obtain a primary vitrified optical fiber preform;
stretching the primary vitrified optical fiber preform by heating it using a heat source that does not use hydrogen;
cutting the primary optical fiber perform to obtain a cut primary optical fiber perform;
growing an outer clad on the cut primary optical fiber preform by soot deposition along a central axis direction thereof to obtain a secondary soot perform; and
dehydrating and sintering the secondary soot preform to obtain a secondary vitrified optical fiber perform.

15. The method of claim 14, wherein the dehydrating step further comprising the step of heating the primary soot preform in a chlorine (Cl₂) atmosphere to remove OH group and impurities that exist inside the primary soot perform.

16. The method of claim 15, wherein the outer clad has a refractive index that is higher than that of an inner clad of the cut primary optical fiber perform and lower than that of a core thereof; and
the step of growing the secondary soot preform further comprises forming the outer clad on an outer circumference of the inner clad.

17. The method of claim 16, wherein the step of dehydrating and sintering the secondary soot preform further comprises the step of simultaneously heating the secondary soot preform in a Cl₂ gas atmosphere to eliminate OH group and impurities, which exist inside the secondary soot preform, and sintering the secondary soot preform in an He gas atmosphere to vitrify the secondary soot preform.
